(19) United States
(12) Patent Application Publication
(10) Pub. No.: US 2014/0013286 A1
(43) Pub. Date: Jan. 9, 2014

(54) METHOD FOR MANUFACTURING A MASK

(71) Applicants: ChungTe HSUAN, Hsinchu (TW); Chao-Lung LO, Jhubei (TW); Yi-Yien TSAI, Bade (TW)

(72) Inventors: ChungTe HSUAN, Hsinchu (TW); Chao-Lung LO, Jhubei (TW); Yi-Yien TSAI, Bade (TW)

(73) Assignee: MACRONIX INTERNATIONAL CO., LTD., Hsinchu (TW)

(21) Appl. No.: 13/542,119

(22) Filed: Jul. 5, 2012

(51) Int. Cl. G06F 17/50

(52) U.S. Cl. 716/52

(57) ABSTRACT

A target pattern and a mask pattern are provided. The target pattern is segmented into a plurality of segments. Each segment includes at least one evaluation point. A first contour of a structure based on the mask pattern is simulated. A distortion between the first contour and the target pattern is evaluated at the evaluation point. At least one of the plurality of segments having a distortion exceeding a threshold value is identified. The identified segment is dissected into at least two sub-segments.

### TECHNICAL FIELD

The present application relates generally to semiconductor devices and includes methods and structures for improving optical proximity correction (OPC) of mask patterns.

### BACKGROUND

To transfer an integrated circuit pattern onto a layer of a semiconductor device (for example, a semiconductor wafer), a mask pattern sometimes referred to as a photo mask is designed first. The pattern on the mask pattern is then transferred to a layer (for example, a photo resist layer) of the semiconductor device by performing a lithography process (for example, a photolithographic process).

As the design pattern of integrated circuits becomes smaller and the mask pattern becomes of higher density in its pattern arrangement, an optical proximity effect during the lithography process causes overexposure or underexposure of the layer of the semiconductor device associated with features such as corners in the mask pattern. This results in a resolution loss that causes formations of round profiles at those corners sometimes referred to as a corner rounding effect. These variations result in a pattern on the layer of the semiconductor device that may be very different from the original mask pattern.

One approach to address this problem is to perform optical proximity correction (OPC) of a mask pattern so that a corrected pattern is formed on the layer of the semiconductor device to suppress the optical proximity effect.

However, OPC is computationally extremely complex requiring many iterations and significant periods of time to perform the mask correction.

It would be desirable to reduce the computational complexity of OPC and improve turn around time on mask correction processing.

### SUMMARY

According to an aspect, a target pattern and a mask pattern are provided. The target pattern is segmented into a plurality of segments. Each segment includes at least one evaluation point. A first contour of a structure based on the mask pattern is simulated. A distortion between the first contour and a target pattern is evaluated at the evaluation point. At least one of the plurality of segments having a distortion exceeding a threshold value is identified. The identified segment is dissected into at least two sub-segments.

### BRIEF DESCRIPTION OF THE DRAWINGS

FIG. 1 is a top view of mask patterns and a wafers.

FIG. 2 is a top view of mask patterns and simulated contours in a OPC process.

FIG. 3 is top views of mask patterns.

FIG. 4 is top views of mask patterns.

FIG. 5 is top views of mask patterns.

FIG. 6 is a flow diagram of an OPC process.

### DETAILED DESCRIPTION

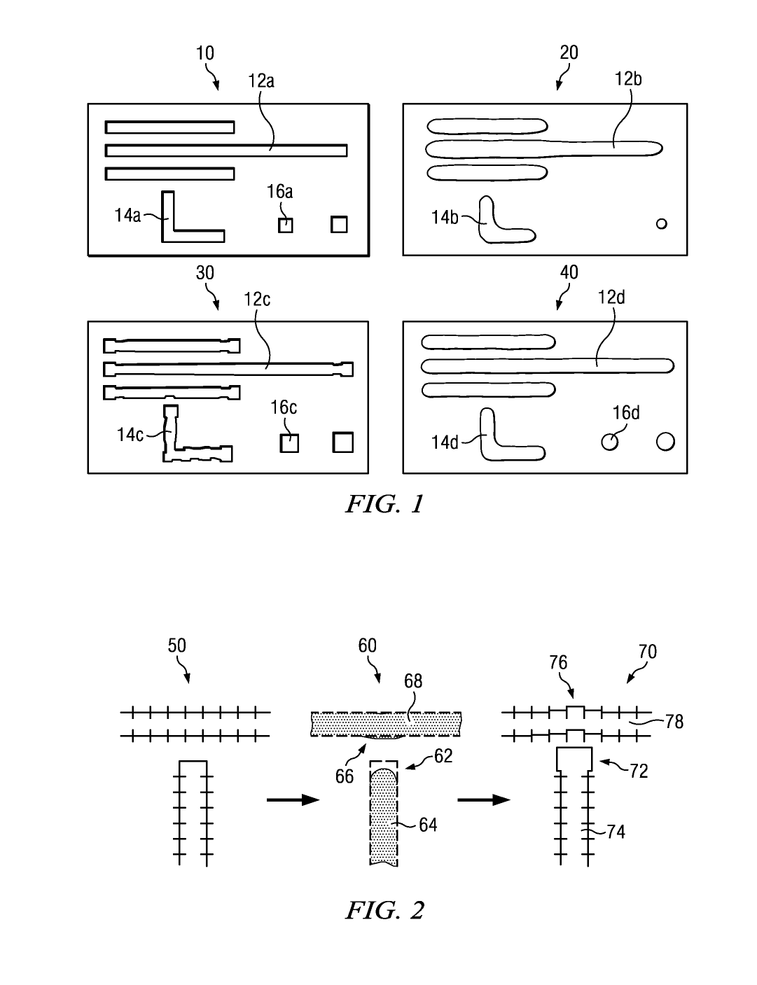

Referring to FIG. 1, a mask 10 including a target pattern is shown. A wafer 20 shows a structure formed by performing a photolithography process using the mask 10. The structure formed on the wafer 20 includes variations from the desired target pattern. For example, the mask 10 includes a pattern 12a for a line (or space). The corresponding formed structure 12b has varied widths along the formed line. As another example, the pattern 14a for a bent line corresponds with the structure 14b, which includes a poorly formed shape near the bend. Also, the pattern 16a, for a hole structure, has not been printed on the wafer 20 at all.

The mask 30 includes a pattern than has been corrected by an optical proximity correction (OPC) process. The outlines of the patterns 12c, 14c, 16c have been adjusted to compensate for the optical proximity effect to obtain formed structures that more closely correspond with target pattern.

A wafer 40 shows a structure formed by performing a photolithography process using the mask 30. The formed structures more closely correspond with the target pattern. For example, the structure 12d more closely corresponds with the target pattern 12a for a line and has a more consistent width. As another example, the structure 14d more closely corresponds with the target pattern 14a having a better defined bend in the line. Also, the structure 16d for a hole has been printed.

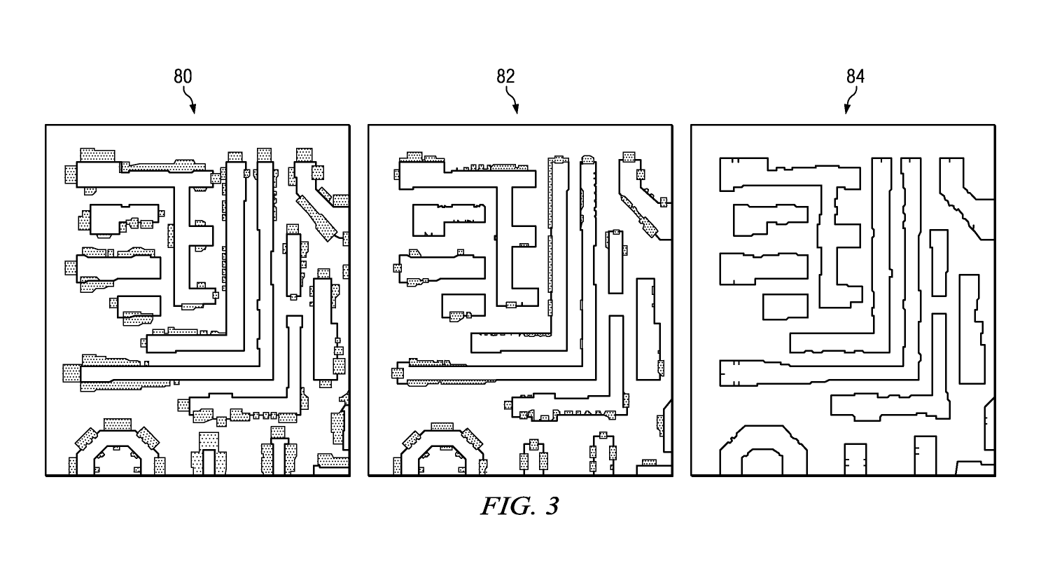

FIG. 2 shows an example of an OPC process. A target pattern 50 is divided into segments. A simulation of the contour produced by the pattern 50 is shown as the structure 60. The structure 60 includes a distortion at the end portion 62 of the line segment 64 and the middle portion 66 of the line segment 68. The end portion 62 is rounded and shortened as compared to the target pattern 50 and the middle portion 66 is shifted towards the line segment 64. The simulated contour of the structure 60 is evaluated according to the segments of the target pattern 50. Where there are distortions, a bias is applied to the mask to compensate. For example, the corrected mask 70 is biased larger at the end portion 72 of the line segment 74 and the middle portion 76 of the line segment 78 is biased away from the line segment 74. Thus, a structure formed by the corrected mask 70 will more closely correspond with the target pattern 50.

As shown in FIG. 3, the OPC process may be performed iteratively. In a first iteration 80, there may be relatively large differences between the target pattern and the simulated contour. Adjustments are made to the mask pattern and a second iteration 82 is performed. In the second iteration 82, the differences between the target pattern and the simulated contour are smaller, but improvements can still be made and the mask pattern is adjusted again in a third iteration 84. Following the third iteration 84, the distortion may be below a threshold and the iterations are stopped.

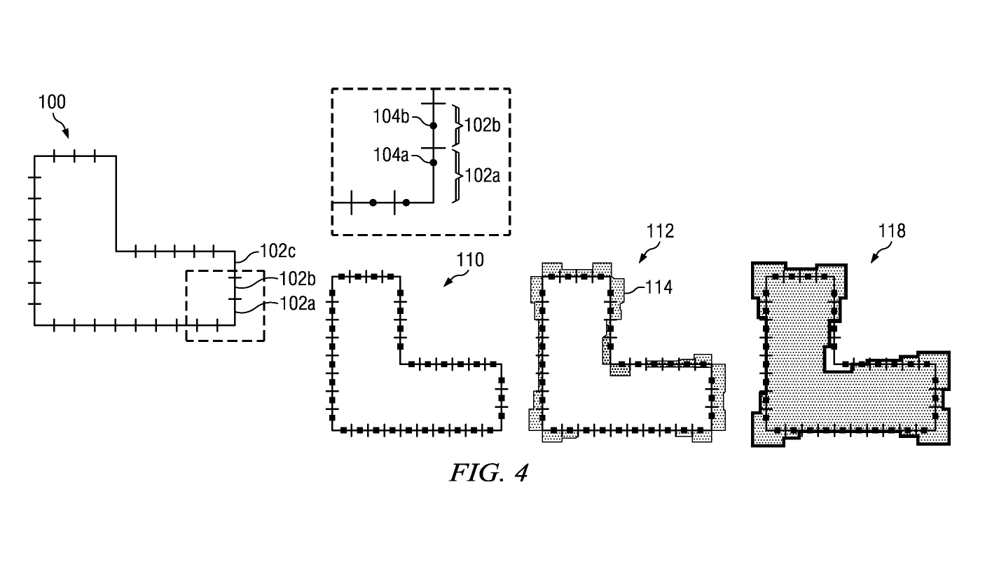

FIG. 4 illustrates an exemplary OPC process that transforms a target pattern into an OPC mask pattern. Referring to FIG. 4, a perimeter of a target pattern 100 is dissected into segments 102a, 102b, 102c, etc. Evaluation points 104a, 104b, etc are selected between the endpoints of the segments, for example at the midpoint. However, the evaluation points may be selected using other criteria such as at the endpoints of the segments or other points. Target pattern 110 shows the segments and evaluation points identified along the perimeter of the pattern.

Then, a simulation process is performed to obtain a simulation of the contour 112 of a structure produced by the target pattern 110, an distortion (or error) is evaluated at each evaluation point and a compensating bias is determined for each segment. The shaded portions 114 illustrate a compensating bias for a distortion between the simulated contour and the target pattern. Then, the perimeter of the mask feature is adjusted based on the distortion to form a corrected pattern 118.

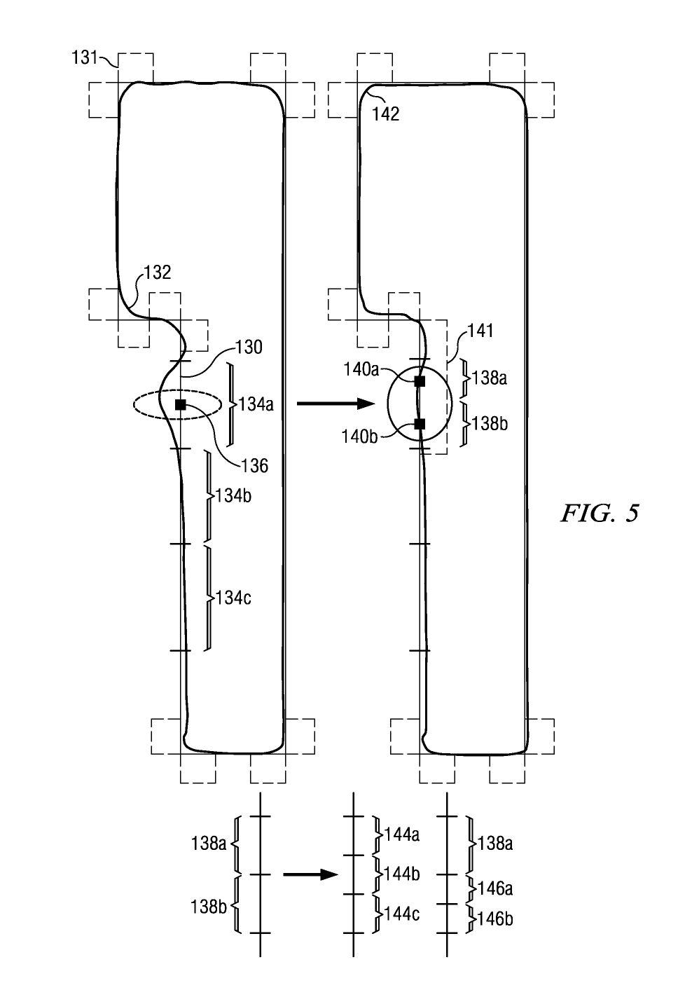

FIG. 5 shows the details of an exemplary OPC process. An OPC process , such as that shown in FIG. 4, may be performed, for example, on a target pattern 130 to obtain a first mask pattern 131A first simulation process is performed on the first mask pattern to obtain a first simulated contour 132.

Referring to FIG. 5, a target pattern 130 is shown with a first simulated contour 132. The perimeter of the target pattern 130 is dissected into segments 134a, 134b, 134c, etc. Evaluation points, such as evaluation point 136, are selected in the segments. A distortion (separation distance) between the simulated contour 132 and the target pattern 130 is present at the evaluation point 136. In this embodiment, the evaluation point 136 has a larger distortion than a reference value.

Subsequently, the segment 134a associated with the evaluation point 136 is dissected into smaller segments 138a and 138b having evaluation points 140a and 140b respectively and the OPC process is implemented on the smaller segments 138a and 138b by using biases associated with the increased dissection to provide a second mask pattern 141. Then, a second simulation process is performed according to the second mask pattern to provide a second simulated contour 142, which has better convergence with the target pattern 130. Thus, finer adjustments in the mask pattern may be made to provide a better correlation of the formed structure with the target pattern without the additional computational complexity of applying smaller segments to the entire mask pattern.

A divergence at an evaluation point may be calculated as a difference between the simulated contour and the target. If the difference is greater than a threshold, more evaluation points may be added. The number of added evaluation point may be a set number (for example two), or it may vary based on the magnitude of the difference. For example, if the difference is greater than X, the segment may be dissected into X sub-segments.

On subsequent iterations, it is not necessary to re-evaluate the entire simulated contour and instead, only those areas of the mask where additional segments were added may be evaluated. Thus, the computational complexity of subsequent iterations can be reduced. Also, in subsequent iterations, the segments may be individually evaluated or the dissected segments associated with a previous segment of the previous iteration may be grouped together.

For example, the segments 138a and 138b may be separately evaluated for further dissection or they may be considered together as a part of the segment 134a, which was dissected in the previous iteration to create the segments 138a and 138b.

In the latter case, an average distortion of the segments is determined. For example, if the segment 138a deviates 2 measurement units to the outside of the target pattern and the segment 138b deviates 3 measurement units to the inside of the target pattern, an average distortion of (2+3)/2=2.5 measurement units is determined. If the average distortion exceeds a threshold, for example 2 measurement units, then further dissection is performed. If not, then the OPC process is completed.

In this example, the average distortion exceeds the threshold and further dissection is performed. A number of methods for further dissection may be used. For example, a total number of dissections may be increased. That is, the portion of the perimeter covered by the two segments 138a and 138b may be dissected into three segments 144a, 144b and 144c. As another example, the segment having the larger divergence, in this case 138b, may be further divided into the segments 146a and 146b. The number of added segments may be a set number (for example two), or it may vary based on the magnitude of the difference. For example, if the divergence is greater than Y, the segment may be further dissected into Y sub-segments.

The addition of sub-segments provides more evaluation points and better correction result while limiting the addition of computational complexity to those regions where convergence is to be improved. An overall lower computational complexity is achieved as compared to performing the correction with a smaller segment size throughout the model.

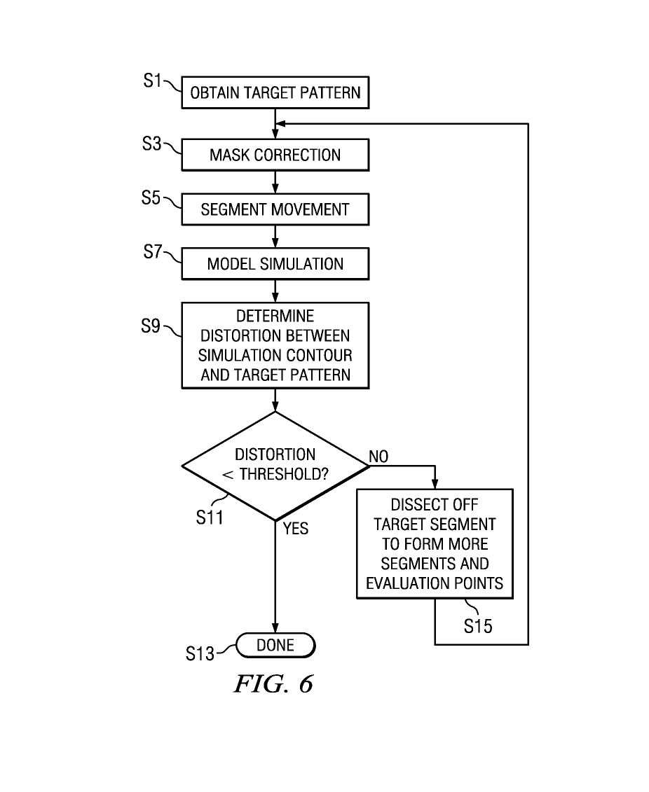

FIG. 6 shows a flow chart of a correction process. The correction process may be executed by a special purpose processor/computer or a general purpose processor programmed to execute the process. The correction process may also be in the form of computer executable instructions that, when executed by a processor, cause the processor to execute the correction process. The computer executable instructions may be stored on one or more computer readable mediums in whole or in parts.

At step S1, the target pattern is obtained. The target pattern may be obtained by providing a computer file containing the target pattern in a standard or proprietary format or by obtaining the target pattern from a database of patterns.

At step S3, a mask correction iteration is performed. In the initial mask correction iteration, the perimeter of the target mask pattern is dissected into segments containing evaluation points and the contour of a structure resulting from a lithography process using the target mask pattern is simulated. The distortion between the target mask pattern and the simulated contour is determined and a bias for each segment is determined based on the determined contour.

Note that an initial mask as the target mask pattern is described here as an exemplary embodiment. A partially corrected mask pattern may also be used as an initial mask pattern.

At step S5, the segments of the mask pattern are moved according to the determined bias to form a corrected mask pattern.

As step S7, a contour of a structure resulting from a lithography process using the corrected mask pattern is simulated.

At step S9, a distortion between the simulated contour and the target mask pattern is determined.

At step S11, it is determined whether the distortion is below a threshold. If yes, then the process continues to step S13 and is completed. If no, then the process continues to step S15 and off-target segments are dissected to form more segments and evaluation points. In adding more segments, a fixed number of segments or a number of segments chosen based on a magnitude of the distortion may be added. The process then returns to step S3.

In subsequent iterations, the mask correction performed at step S3 may be limited to the areas where more segments and evaluation points have been added. For example, if n iterations are performed, the localized dissection of segments determined to be off-target may be performed in the second to n-th iterations.

Also in subsequent iterations, the determination of whether the distortion is below a threshold at step S11 may average the segments added within a previous or original segment. In subsequent iterations, the adding of segments at step S15 may add segments to all segments or may be limited to only a certain number, such as one, sub-segment within a previous or original segment. The segment that is further dissected may be selected based on which segment has the most significant distortion.

Exemplary benefits of the above-described process include providing finer segmentation for OPC to provide better convergence between a formed structure and a target pattern, reducing computational complexity of the OPC process, and reducing turn around time of OPC of a mask pattern.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

1. A method for correcting a mask pattern, comprising:
providing a target pattern, the target pattern being segmented into a plurality of segments and each segment including at least one evaluation point;
providing a mask pattern;
simulating a first contour of a structure resulting from a lithography process based on the mask pattern;
evaluating a distortion between the first contour and the target pattern at the at least one evaluation point;
identifying at least one distorted segment of the plurality of segments, wherein the distorted segment has a distortion exceeding a threshold value; and
dissecting only the identified at least one distorted segment into at least two sub-segments.

2. The method of claim 1, wherein a number of sub-segments into which the identified at least one distorted segment is dissected in the dissecting step is selected based on a magnitude of distortion at the identified at least one distorted segment.

3. The method of claim 1, further comprising:
applying a bias to at least one of the at least two sub-segments to obtain an adjusted mask pattern;
simulating a second contour of a structure resulting from a lithography process based on the adjusted mask pattern at the at least one evaluation point, the at least two sub-segments each including at least one evaluation point; and
evaluating a distortion between the second contour and the target pattern.

4. The method of claim 3, wherein the evaluating includes averaging a distortion at each of the at least two sub-segments to determine an average distortion for the identified at least one distorted segment from which the at least two sub-segments were dissected.

5. The method of claim 3, further comprising:
identifying at least one of the at least two sub-segments; and
further dissecting the identified at least one of the at least two sub-segments into at least two additional sub-segments.

6. The method of claim 5, wherein the identifying includes identifying the at least one of the at least two sub-segments that has a distortion exceeding the threshold value.

7. The method of claim 5, wherein the identifying includes identifying the at least one of the at least two sub-segments that has a largest distortion among the at least two sub-segments.

8. The method of claim 5, wherein the at least two additional sub-segments comprises a number of sub-segments selected based on a magnitude of distortion at the identified at least one of the at least two sub-segments.

9. The method of claim 3, wherein the simulating includes simulating the second contour in a region of the adjusted mask pattern including the at least two sub-segments and does not include simulating the second contour in another region of the adjusted mask pattern.

10. The method of claim 1, wherein the at least two sub-segments have a same length.
